(19) United States
(12) Patent Application Publication
(10) Pub. No.: US 2013/0060502 A1
(43) Pub. Date: Mar. 7, 2013

(54) THERMAL SCAN SYSTEM

(71) Applicants: Loc ThiXuan Dang, San Jose, CA (US); Kevin Huai Li, San Ramon, CA (US)

(72) Inventors: Loc ThiXuan Dang, San Jose, CA (US); Kevin Huai Li, San Ramon, CA (US)

(21) Appl. No.: 13/223,766

(22) Filed: Sep. 1, 2011

(51) Int. Cl. G06F 19/00

(52) U.S. Cl. 702/108

(57) ABSTRACT

In one embodiment, a system includes an operating environment comprising a structural test module that is configured to perform a structural test on a device-under-test (DUT); and a functional test module that, when activated, is configured to perform a non-JTAG-based functional *test on the DUT. The operating environment is configured to switch between the structural test module being activated and the functional test module being activated.

### FIELD

The present disclosure relates generally to a system for testing electronic systems or components for functional and structural defects.

### BACKGROUND

Electronic devices and/or systems may be tested for structural defects such as defects related to components or solder of the device or the system. Structural tests may be performed on the electronic devices or systems in ambient temperatures. However, performing the structural tests in ambient temperatures may not identify structural defects that may be detectable only after the devices is subjected to harsh environmental conditions, such as when the device or system is operating in the field.

### BRIEF DESCRIPTION OF THE DRAWINGS

FIG. 1 illustrates an example system that may perform diagnostic tests on a device-under-test.

FIG. 2 illustrates an example system having one or more test modules that may be used to perform diagnostic tests on the device-under-test.

FIG. 3 illustrates an alternative system that may perform diagnostic tests on a device-under-test.

FIG. 4 illustrates a flow chart showing an example method that may be used to perform one or more diagnostic tests.

FIG. 5 illustrates a flow chart showing another example method that may be used to perform one or more diagnostic tests.

FIG. 6 illustrates an example computer system that may be used to implement the systems of FIG. 1, FIG. 2 and/or FIG. 3, or other systems to perform diagnostic tests on a device-under-test.

### DETAILED DESCRIPTION

### Overview

A system includes an operating environment comprising a structural test module that, when activated, is configured to perform a structural test on a device-under-test (DUT); and a functional test module that, when activated, is configured to perform a non-JTAG-based functional test on the DUT. The operating environment is configured to switch between the structural test module being activated and the functional test module being activated.

A method includes configuring a device-under-test (DUT) in a test setup that performs a plurality of different types of diagnostic tests, including a structural test and a functional test. The method further includes performing, with at least one processor, a first diagnostic test on the DUT, where the first diagnostic test comprises the structural test or the functional test. In addition, the method includes determining, with the at least one processor, results of the first diagnostic test; and performing, with at least one processor, a second diagnostic test on the DUT, where the second diagnostic test is of a different type than the first diagnostic test, and where the second diagnostic test is performed while the DUT is in the test setup.

### DESCRIPTION OF EXAMPLE EMBODIMENTS

The present disclosure describes a system that is configured to perform at least one functional test and at least one structural test on a device under test (DUT). The DUT may be a device, apparatus, or system that includes one or more electronic components. The DUT may be configured to perform one or more functions. The functions may be logic-based, arithmetic based, and/or control-based, as examples. Alternatively or in addition, the DUT may include one or more electronic components that are configured to perform one or more functions. An electronic component may be an integrated circuit, such as an application specific integrated circuit (ASIC) or a field programmable gate array (FPGA), a processor, a memory, a controller, or an amplifier, as examples. The electronic components may be mounted on one or more circuit boards. Example DUTs 105 may be a router or a switch.

A functional test may be a test of one or more functional capabilities of the DUT. A functional test may determine whether the DUT is capable of performing one or more of the DUT's 105 intended functions, such as an intended logical function. To illustrate, the DUT may be a router, and some of the functions of the router may be to forward data packets across a network, read address information from the data packets to be forwarded, and/or determine where to send the data packets. A functional test may determine whether the router is not forwarding the data packets properly, and/or whether the router is instead, dropping the received data packets, outputting corrupted data packets, or sending the data packets to the wrong location, as examples.

A functional test performed on the DUT may be a system level test or a component level. In the example where the DUT is a router, determining whether the router as a whole is functioning properly may be a functional system test because the functional test is a test of the functionality of the system (i.e., the router) rather than individual components of the router. A functional system test may identify which component or components of the system may be defective and/or may be causing the system to not function properly. Alternatively, the functional test performed on the DUT may be a component-level test that tests the functionality of an individual component of the DUT. A result of the component-level test may or may not be determinative of the functionality of the DUT on a system level. For example, the result of the component-level test may indicate a functional error of a component of the DUT that does not affect the performance of the DUT as a whole.

A defect in the DUT may be introduced during a manufacturing process of the DUT. The defect may affect or alter a behavior of the DUT. A defect may be structurally related. A structurally related defect may be component-based. Examples of component-based defects may include a bent pin of a component, a missing component of the DUT, a misplaced component, a component that is the wrong part, or a component that is a “dead,” or non-operable part. Alternatively, a structurally-related defect may be solder-based. A solder-based defect may be a defect related to one or more portions of solder that connects the component to the circuit board, connects two or more components together, and/or provides circuit connections for circuit elements of a component, such as resistors, capacitors, transistors, and/or diodes.

A solder-based defect may be a patent solder-based defect or a latent solder-based defect. A patent solder-based defect may be a defect that exists immediately or shortly after manufacture of the DUT, may be readily identifiable, may be constant, permanent and/or consistently recurring, may exist in ambient temperatures and/or may be independent of temperature or the environment, may exist without operating in the field, and/or may be detected before the DUT is sent into the field. A patent-based defect may be or may be an absence or a presence of solder where there should not be an absence or a presence. A patent solder-based defect may exist in the form of and/or create an open circuit, a short circuit, or a bridge that bypasses a connection. As an example, a patent solder-based defect may be a missing portion of solder that causes an open-circuit where there should actually be a connection.

A latent solder-based defect may be a defect that may not exist immediately or shortly after manufacture of the DUT, may not be readily identifiable, and/or may be intermittent. In addition or alternatively, a latent solder-based defect may be dependent on temperature and/or the environment. For example, a latent solder-based defect may be detected only after being subjected to temperatures that are hotter or colder than ambient or after being subjected to harsh environmental conditions. Alternatively or in addition, a latent solder-based defect may exist only after operating the DUT in the field. Latent solder-based defects may be related to the quality of the solder, such as insufficient solder, solder having voids, excess solder, cold solder, and/or de-wetted solder balls.

In order to test for a structurally-related defect, a structural test may be performed on the DUT. The structural test may detect, determine, and/or identify one or more structural defects, such as a component-based defect and/or a solder-based defect. Alternatively or in addition, the structural test may not detect, determine, and/or identify whether the DUT and/or one or more components of the DUT is functioning properly and/or whether a detected structural defect is affecting the performance or function of the DUT and/or one or more components of the DUT. For example, a structural test may test for a short circuit or an open circuit without determining whether the short circuit or the open circuit is affecting the functionality of the DUT.

An example structural test is a boundary scan, which may test for structural defects of a component or between two components of the DUT, such as in the periphery of a component (e.g., a leg, bond wire, or driver amplifier), in solder connecting the component to a board (e.g., a printed circuit boards (PCB)), or interconnects between two or more components of the DUT. The boundary scan may be used and/or implemented in accordance with Institute of Electrical and Electronics Engineers (IEEE) standards 1149.1, 1532, and/or 1149.6. The boundary scan test may be a Joint Test Action Group (JTAG) test, and/or may be referred to as a JTAG test or solely, JTAG. In addition or alternatively, a test that includes boundary scan may be referred to as an in-circuit test (ICT).

The DUT and/or one or more components of the DUT may be configured for the boundary scan. For example, the DUT and/or one or more components of the DUT may be configured in accordance with IEEE standards 1149.1, 1532, and/or 1149.6. The DUT and/or one or more components of the DUT may have a test access port (TAP), including a Test Data In (TDI) pin, a Test Mode Select (TMS) pin, a Test Clock (TCK) pin, and a Test Data Out (TDO) pin, and/or a Test Reset (TRST) pin. The DUT and/or one or more components of the DUT may also have a TAP controller, which may be used and/or implemented in accordance with one or more state machines. The DUT and/or one or more components of the DUT may further include one or more registers, such as an instruction register, an identification register, and/or a bypass register, that are used and/or implemented in accordance with IEEE 1149.1, 1532, and/or 1149. The DUT and/or one or more components of the DUT may also have a boundary scan register, which may include one or more boundary-scan cells or memory elements placed on the component's signal inputs ports, output ports, and/or on the control lines of bidirectional (I/O) ports and/or tristate (0, 1, Z) ports. The boundary-scan cells may be configured in a boundary-scan path. The DUT and/or one or more components of the DUT may be configured to receive instructions and/or test signals and output a one or more responses to determine structural defects of the DUT and/or one or more components of the DUT. In some examples, a boundary scan test taken on the DUT and/or one or more components of the DUT may take about two minutes to perform.

To test for latent defects, the DUT may be subjected to thermal testing. Thermal testing may be performed on the DUT before the DUT is deemed suitable for operation and/or being sent in the field. Thermal testing may include a process that subjects the DUT to temperatures hotter than ambient or room temperature for a period of time. An example hotter temperature may be about fifty-five degrees Celsius. In addition or alternatively, the DUT may be subjected to temperatures colder than ambient or room temperature. An example colder temperature may be about minus ten degrees Celsius. The process of subjecting the DUT to hot temperatures and/or cold temperatures may be referred to as a thermal cycle. In some test setups that set and/or maintain temperatures, the DUT may be subjected to the thermal cycle in an area, such as a test chamber, where the temperature may be controlled, set, and/or maintained. The DUT may be mounted in or on a support device, such as a chassis, in the test chamber. Thermal testing may simulate the DUT's 105 operability in the field after production, where the DUT may be subjected to harsh environmental conditions.

In some systems, functional and structural testing may be performed on the DUT using two different test setups. For example, the DUT may be configured in a first test setup that is configured to perform one or more structural tests, such as one or more boundary scans. The DUT may be positioned in the first test setup in an ambient environment. After the structural test is performed, the DUT may be moved to a second test setup that is configured for performing one or more functional tests on the DUT. In the second test setup, the DUT may be positioned in a test chamber and subjected to one or more thermal cycles of hot and/or cold temperatures. In some example test setups, the DUT may be subjected to a hot temperature or a cold temperature for about ninety minutes, although other time periods may be used. During the one or more thermal cycles, one or more functional tests may be performed on the DUT. The functional tests may be used to determine, identify, and/or detect whether the DUT or one or more components of the DUT is performing one or more functions properly. However, the functional tests may not determine, identify, and/or detect a structural defect of the DUT or one or more components of the DUT that may be causing the DUT to function improperly.

Detecting and/or identifying structural defects may facilitate a functional test in a diagnosis and/or an evaluation of the DUT. For example, if a functional test reveals a functional error in the DUT, a structural test may facilitate in identifying one or more structural defects in one or more components of the DUT that are causing the functional error. Where the DUT is being subjected to functional testing during one or more thermal cycles in a test chamber, switching to structural testing while the DUT is being subjected to the thermal cycle, without removing the DUT from the test chamber, and/or without moving the DUT to a different test setup may improve and/or speed up the overall testing and/or diagnosis of the DUT and may also reduce test equipment and/or overall costs of the testing.

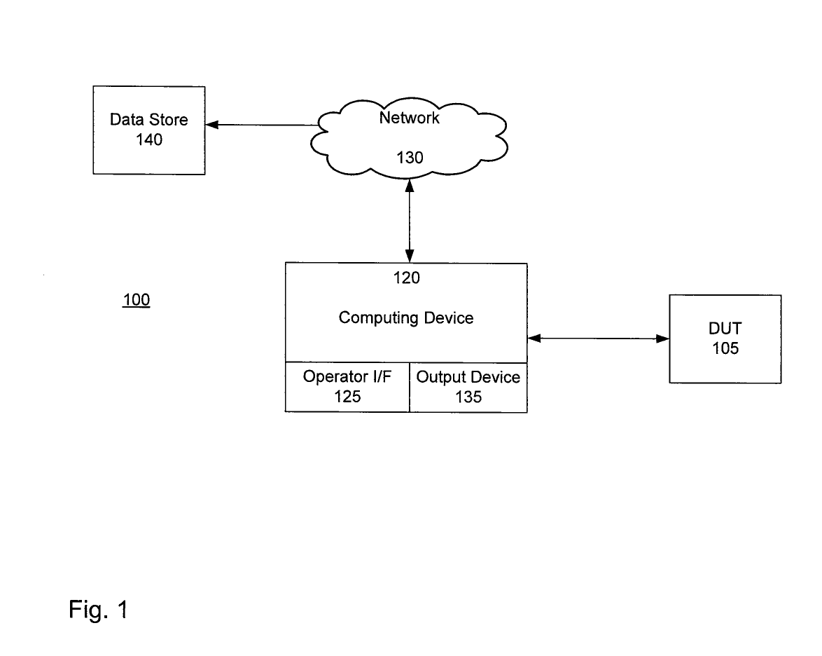

FIG. 1 provides an example of a general overview of a system 100 that may be used to perform at least one functional test and at least structural test on a DUT 105. Not all of the depicted components may be required, however, and some implementations may include additional components. Variations in the arrangement and type of the components may be made. Additional, different or fewer components may be provided.

The system 100 may include a computing device 120, a network 130, and a data store 140. The computing device 120 may display or otherwise provide an operator interface 125 for use by an operator to control the testing of the DUT 105. The operator may be a person that controls the testing of the DUT 105 via the operator interface 125. The operator may use the operator interface 125 to determine and/or select a testing mode, to identify one or more components of the DUT 105 to test, to determine and/or select one or more test signals to send to the DUT 105, and/or to determine various test parameters associated with the one or more structural tests and/or one or more functional tests, as discussed in further detail below.

The data store 140 may be operative to store any information needed to perform a structural test and/or a functional test. The data store 140 may include one or more relational databases or other data stores that may be managed using various known database management techniques, such as, for example, SQL and object-based techniques. Alternatively or in addition the data store 140 may be implemented using one or more of the magnetic, optical, solid state or tape drives, or other storage medium available now or later developed. The data store 140 may be in communication with the computing device 120 through the network 130. For example, the data store 140 may be a database server running database software, such as MICROSOFT SQL SERVER®, ORACLE®, IBM DB2® or any other database software, relational or otherwise. Alternatively or in addition, the data store 140 may be in communication with other computing devices, such as servers, through the network 130.

The network 130 may include wide area networks (WAN), such as the internet, local area networks (LAN), campus area networks, metropolitan area networks, or any other networks that may allow for data communication. The network 130 may include the Internet and/or the network 130 may be divided into sub-networks. The sub-networks may allow access to all of the other components connected to the network 130 in the system 100, or the sub-networks may restrict access between the components connected to the network 130. The network 130 may be regarded as a public or private network connection and may include, for example, a virtual private network or an encryption or other security mechanism employed over the public Internet, or the like.

The computing device 120 may be connected to the network 130 in any configuration that supports data transfer. This may include a data connection to the network 130 that may be wired or wireless. The computing device 120 may run a web application on any platform that supports web content, such as a web browser or a computer, a mobile phone, personal digital assistant (PDA), table PC, and/or any appliance or device capable of data communications.

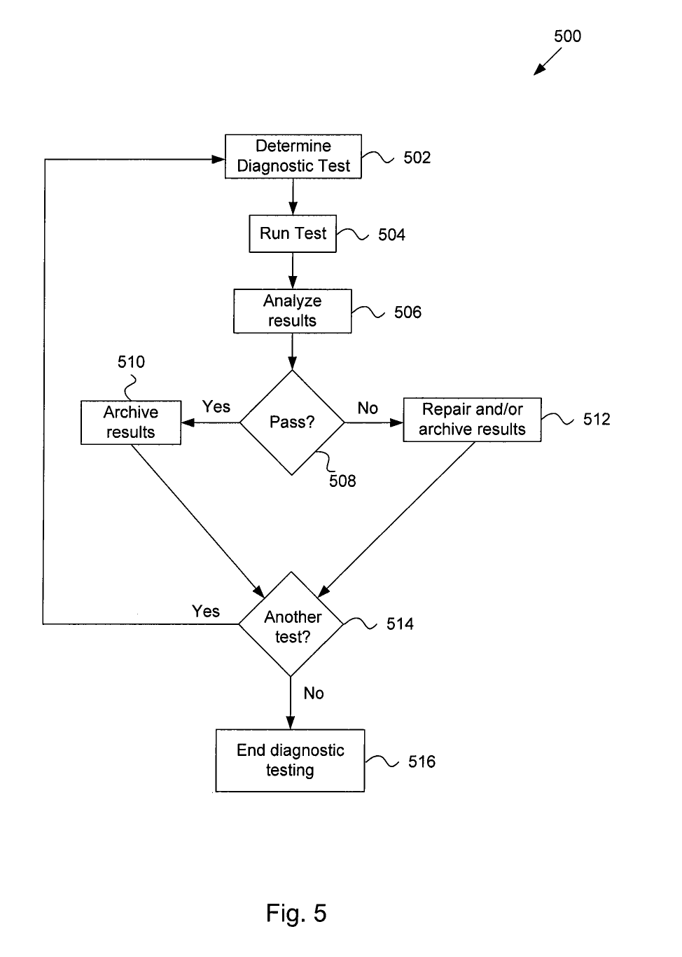

The computing device 120 may be a machine that has a processor and memory. The computing device 120 may also include or be in communication with a display, an operator interface, such as the operator interface 125, and a communication interface, such as described in connection with the computing device described in FIG. 5 below. The processor may be operatively coupled with the memory, display and the interfaces and may perform tasks at the request of one or more standalone applications or an underlying operating system. Herein, the phrase “coupled with” is defined to mean directly connected to or indirectly connected through one or more intermediate components. Such intermediate components may include both hardware and software based components. The memory may be capable of storing data. The display may be operatively coupled with the memory and the processor and may be capable of displaying information to the operator. The operator interface 125 may be operatively coupled with the memory, the processor, and the display and may be capable of interacting with an operator. The operator interface 125 may be configured to receive inputs from the operator, and based on the input, the processor, coupled with the operator interface 125, may be configured to generate one or more signals for performing the functional test and/or one or more signals for performing the structural test. The communication interface may be operatively coupled with the memory, and the processor, and may be capable of communicating through the network 130 and to the data store 140 and/or to the DUT 105. In other embodiments, the computing device 120 may communicate with the DUT 105 through the network 130. The standalone application may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, amongst others.

The computing device 120 may be any mobile device that has a data connection and may run a mobile application. The data connection may be a cellular connection, a wireless data connection, an internet connection, an infra-red connection, a Bluetooth connection, or any other connection capable of transmitting data. For example, the mobile application may be an application running on an iPhone™ available from Apple, Inc.

The computing device 120 may be configured to send, such as through the communication interface, one or more signals to the DUT 105 to perform one or more structural tests and/or one or more signals to perform one or more functional tests. In addition, the computing device 120 may be configured to be in a structural testing mode when sending the structural testing signals and/or be configured to be in a functional testing mode when sending the functional testing signals. In addition or alternatively, the computing device 120 may be configured to switch between the modes. For example, the computing device 120 may be configured to switch from the structural testing mode to the functional testing mode, and/or switch from the functional testing mode to the structural testing mode.

The structural test signals and/or the functional test signals may be sent to the DUT 105 and a response may be received by the computing device 120 from the DUT 105. Based on the response, the computing device 120 may determine whether one or more defects exist, what the one or more defects may be, and/or what actions may be taken to correct the one or more defects. The structural test signals and/or the functional test signals may comprise instructions and/or patterns, such as test patterns. The instructions may identify the test and provide the parameters to perform the test. The test patterns may provide the input information on which to perform the test. The patterns may include sequences and/or combinations of sequences of values and/or characters. The values may be binary or hexadecimal values, although other types of values may be used. A pattern may be in the form of one or more vectors. An expected response pattern may be associated with the test pattern. If an actual response (e.g., the response from the DUT 105), matches the expected response, then the computing device 120 may determine that the DUT 105 does not have any defects. Alternatively, if the actual response differs from the expected response, then the computing device 120 may determine that one or more defects are present.

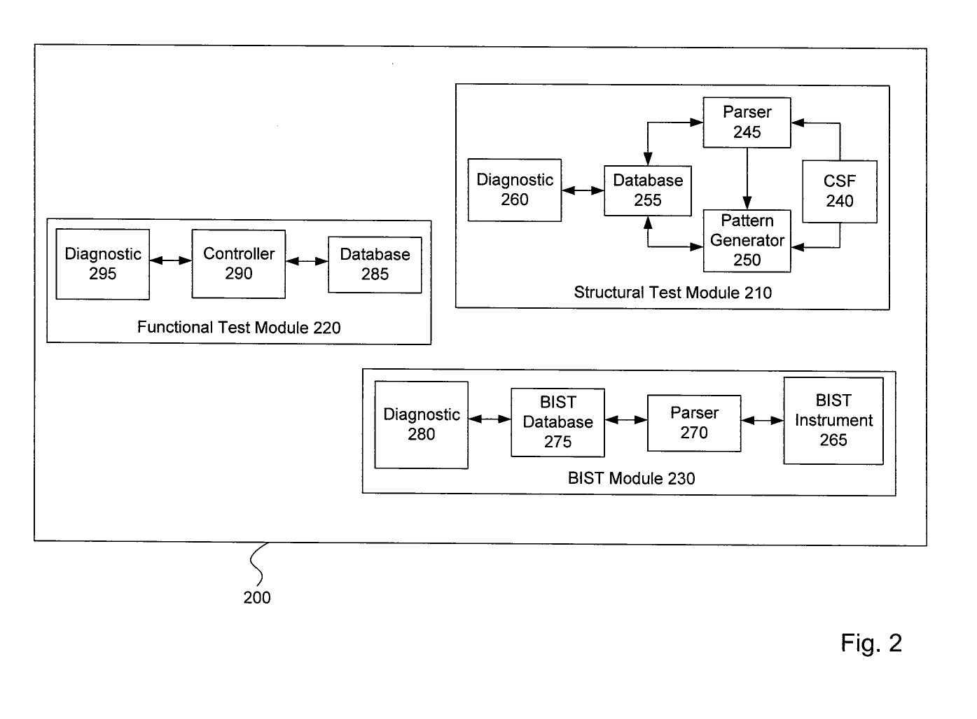

FIG. 2 shows a system 200 that may be used by and/or implemented in the computing device 120 to perform one or more structural tests and/or one or more functional tests on the DUT 105. The system 200 may be hardware-based, software-based, and/or a combination thereof. For example, the system 200 may be the underlying operating system of a computing device. The system 200 may include a structural test module 210, a functional test module 220, and/or a built-in self test (BIST) module 230. Each of the structural test module 210, the functional test module 220, and/or the BIST module 230 may be hardware-based or software-based. For example, each of the modules 210, 220, and/or 230 may be a computer program, an application, or an operating system environment within the system 200. Alternatively, at least one of the modules 210, 220, 230 may be separate from the system 200, and the system 200 may be configured to access, communicate with, and/or utilize one or more functions of the at least one of the modules 210, 220, 230 that is separate from the system 200.

The structural test module 210 may be configured to determine and/or generate one or more test signals to perform the structural testing. In one example, the structural test module 210 may be configured to provide one or more test signals to perform a boundary scan test. The structural test module 210 may be configured and/or utilized in accordance with IEEE standards 1149.1, 1532, and/or 1149.6. For example, where the DUT 105 is configured for a boundary scan test in accordance with IEEE 1149.1, 1532, and/or 1149.6, the structural test module 210 may be configured to generate instructions and/or one or more test signals that may be provided to and/or used by one or more TAP pins, one or more TAP controllers, one or more boundary scan cells, and/or one or more registers of the components of the DUT 105. The test signals may include instructions, such as IDCODE, BYPASS, SAMPLE, PRELOAD, EXTEST, EXTEST_PULSE, EXTEST_TRAIN, and/or HIGHZ instructions, that identify and/or determine the structural test to be performed and/or one or more parameters used to perform the structural test. IDCODE may be used to identify a manufacturer of the component of the DUT 105 receiving the instructions. BYPASS may be used to control the bypass register of the component of the DUT 105 undergoing the boundary scan test, which may comprise a single shift-register, and/or which may include a minimum-length serial path between a test data in (TDI) and test data out (TDO) pins of the component of the DUT 105. The SAMPLE instructions may allow a snapshot to be taken of the states of the component of the DUT's 105 input and output signals without interfering with the normal operation of the DUT 105 or the component of the DUT 105 receiving the test. In addition, the SAMPLE instructions captures data into the boundary scan register and allows the boundary scan register to be shifted out through the TDO pin for examination. PRELOAD instructions shift data into the boundary-scan register through the TDI pin such that the data may be loaded into the boundary-scan register's parallel output registers and/or latches in advance of selecting an instruction (such as EXTEST) that supplies the data held in the parallel output registers or latches to the component of the DUT's 105 output pins. EXTEST instructions allow circuitry external to the component of the DUT 105 undergoing the boundary scan test, typically a board interconnect, to be tested. During EXTEST testing, boundary scan register cells at output pins of the component of the DUT 105 may be used to apply test stimuli, and boundary scan register cells at input pins of the component of the DUT 105 may capture results of the test. EXTEST_PULSE instructions may implement test behaviors for alternative current (AC) and/or time-varying voltage pins and may provide test behaviors that behave in accordance with IEEE 1149.1 EXTEST instructions for direct current (DC) and/or static voltage level pins of the component of the DUT 105. The EXTEST_PULSE instruction may enable edge detecting behavior on signal paths containing AC pins. In addition or alternatively, a charge/discharge time when executing EXTEST_PULSE instructions may be determined by time spent in a Run-Test/Idle TAP Controller state, as defined by the JTAG standard. EXTEST_TRAIN instructions may provide test behaviors for AC and/or time-varying voltage pins of the component of the DUT 105 and may provide test behaviors that behave identically to IEEE 1149.1 EXTEST for DC current and/or static voltage level pins of the component of the DUT 105. The EXTEST_TRAIN instructions may enable edge-detecting behavior on signal paths containing AC pins. In addition or alternatively, the charge/discharge time when executing EXTEST_TRAIN instructions may be determined by direct manipulation by a TCK period, as defined by the JTAG standard. In addition, the test signals may include one or more test patterns, including one or more test vectors, that provide the test input data and/or instructions for the structural test. By providing the test signals for performing the boundary scan test, including the instructions and/or the data, the structural test module 210 may be configured to control one or more TAP controllers of the DUT 105 or of one or more components of the DUT 105.

As shown in FIG. 2, an example structural test module 210 may include a Component and System Files (CSF) database 240. The CSF database 240 may include information about the DUT 105, such as the parts or components of the DUT 105 and/or the connections that connect the parts or components together. The CSF module 240 may include data and/or files that provide a description of how the structural test may be implemented in the DUT 105, and/or how the structural test operates. One type of data Boundary Scan Description Language (BSDL) data. The description may include an entity description, a generic parameter, a logical portion description, a use statement, a pin mapping, a scan portion identification, an instruction register description, a register access description, and/or a boundary register description.

The entity statement may include a name of the DUT 105. The generic parameter may include a package type, which provides a declaration of the pins of the DUT 105. The logical port description may include one or more names of input/output pins of the DUT 105 and/or the TAP pins of the DUT 105. The logical portion description may also identify a type for each of the pins, such as “input,” “output,” and/or “bidirectional,” as examples. The use statement may include external definitions used in a package of the DUT 105. The pin mapping may include a mapping of logical signals onto the pins of the DUT 105. The scan port identification may define a test access port (TAP) of the DUT 105. The instruction register description may include a description of characteristics of the instruction register of the DUT 105, such as instructions as defined in IEEE 1149.1, 1532, and/or 1149.6, including BYPASS, IDCODE, HIGHZ, EXTEST, EXTEST_PULSE, and/or EXTEST_TRAIN. The register access description may identify a register that is placed between a Test Data In (TDI) pin and a Test Data Out (TDO) pin of the TAP pins of the DUT 105. The boundary register description may include a list of one or more boundary-scan cells and/or information pertaining to a cell type and control of the boundary-scan cells.

Alternatively or in addition, the CSF database 240 may also include Bill of Material (BOM) data, which may include a part number of the DUT 105 and/or a design part number of a printed circuit board (PCB) of the DUT 105. Alternatively or in addition, the BOM data may include a description of the PCB design, a revision number of the PCB design, a name of an organization to which the PCB design belongs, and/or a list of one or more components and/or parts that may be used and/or required to assemble the PCB. The BOM data may also contain: an item sequence in numerical order, a part number, a part type (e.g., capacitor, a resistor, ASIC, memory types, connectors), a quantity of components or parts to be used, and/or one or more reference designators for the components and/or parts to be used on the DUT 105 or the PCB design. In one example, the BOM data may include a list of only the components and/or parts that are required in the PCB design.

Alternatively or in addition, the CSF database 240 may include Netlist data. The Netlist may provide a description of a schematic design of the DUT 105. In one example, the Netlist data is a text file. The Netlist data may include a list of some or all of the components and/or parts of the DUT 105 and/or a list of some or all pin-to-pin connectivity of the components of the DUT 105. The Netlist data may comprise information about both “non-required” components and required components of the DUT 105. A required component may be a component of the DUT 105 whose presence and/or operability is necessary and/or required for the DUT 105 to perform one or more of its intended functions. The Netlist data may include a net name for one or more nets of the DUT 105. A net may be a single pin of the DUT 105 that is not connected to any other pin (i.e., a no-connect pin), or alternatively, a net may be a connection that connects one or more pins.

The CSF database 240 of the structural test module 210 may be a component and/or part of storage, such as the memory, of the computing device 120. Alternatively, the CSF database 240 may be a component and/or part of data store 140.

The structural test module 120 may further include a test pattern generator 245, such an Automatic Test Pattern Generator (ATPG), in communication in communication with the CSF database 240. The test pattern generator 245 may generate the test patterns that the controller 110 may use to perform the structural test on the DUT 105. In one example, the test pattern generator 210 may generate the test patterns based on information provided by the CSF module 240, including the BSDL data, the BOM data, and/or the Netlist data. The test pattern generator 245 may comprise and/or use one or more algorithms to generate the test patterns. The algorithms may generate various types of test patterns, including counting patterns and/or binary count patterns, walking one patterns, walking zero patterns, Wagner patterns, binary count test Wagner patterns, combinations thereof, or other test patterns that may be used and/or generated to perform a structural test, including patterns used to identify fault coverage for stuck-at pins, shorts, and/or opens between parts (such as boundary-scan parts), and/or patterns that may be used to test one or more driver sets on each node of the DUT 105. The algorithms may use some or all of the information contained in the BSDL data, the BOM data, and/or the Netlist data as inputs to generate test pattern outputs.

In one example, some or all of the information in the CSF database 240, including the BSDL data, the BOM data, and/or the Netlist data, may be parsed by a parser 250 before the test pattern generator 245 may use the information in the CSF database 240 to generate one or more test patterns. The parser 250 may receive the BSDL data, the BOM data, and/or the Netlist data from the CSF module 240 and compile or convert the BSDL data, the BOM data, and/or the Netlist data into a data format or a data structure that the test pattern generator 245 may be configured to process to generate the test pattern. In other example structural test modules, the parser 250 may not be included.

The structural test module 120 may further include a database 255 in communication with the test pattern generator 245, and/or the parser 250. Some or all of the information generated and/or provided by the test pattern generator 245 and/or the parser 250 may be stored in the database 255. In addition or alternatively, the test pattern generator 245 may be configured to access the database 210 to generate the test patterns. The database 255 may be a component or part of the storage of the computing device 120, such as the memory of the computing device 120. Alternatively, the database 255 may be a component or part of data store 140.

The structural test module 210 may further include a diagnostic module 260. The diagnostic module 260 may be configured to determine whether a structural defect exists based on a received response of the DUT 105. For example, the diagnostic module 260 may be configured to compare an expected response associated with an input test pattern with an actual response of the DUT 105 to determine whether a structural defect exists, the type of structural defect (e.g., open, short), and/or the component and/or net that has the defect. The diagnostic module 260 may be configured to provide an output to the operator of the system 100, such as to the display of the computing device 120, that includes the results of the structural test.

The system 200 may further include a functional test module 220. The functional test module 220 may include one or more diagnostic tests that check the health of components of the DUT 105 and/or verify proper operation of the DUT 105 and/or control paths of the DUT 105. In some examples, functional tests may include system level functional tests that verify proper functioning of the DUT 105 and are not concerned with the functionality and/or operation, such as logic operations, of individual components of the DUT 105. Alternatively or in addition, functional tests may verify the proper functioning of a component of the DUT 105 (such as an ASIC or an FPGA), and are not concerned with the proper functioning of individual circuit elements of the component, such as the CPU or memory. A function test may validate and/or demonstrate correct behavior of the DUT 105 as defined by requirements, specifications, and/or design. A functional test may test the functionality of the DUT 105 (e.g., a data or network traffic test) or the functionality of one or more components or types of components of the DUT 105, such as memory, a processor (e.g., a central processing unit (CPU)), logic, packaging, network connectivity (e.g., Ethernet) test, and/or fabrication test, as examples. In addition or alternatively, functional tests performed using the functional test module 220 may not include any functional testing that may be performed in accordance with the JTAG standard. In addition or alternatively, functional tests may include digital functional tests that test one or more digital operations of the DUT 105 and/or one or more components of the DUT 105. In addition or alternatively, functional tests may include tests that verify electrically programmable logic device (EPLD), field programmable gate array (FPGA), central processing unit (CPU), and/or basic input/output system (BIOS) revisions; tests that verify a Small Form-Factor Pluggable (SFP) type; tests that verify functionality of an active clock; external loopback tests; line card snake tests; individual port tests; and/or system traffic tests. Functional tests may be used and/or grouped in different tests areas, test phases, test functions, and/or test departments, which may include ongoing reliability test (ORT), a high accelerated life test (HALT), an electronic design validation test (EDVT), a post silicon validation (PSV), or a failure analysis (FA).

The functional test module 220 may be configured to activate and/or execute one or more functional tests. Also, one or more of the functional tests may be activated and/or executed at one or more predetermined phases of a manufacturing process of the DUT 105. In one example, one or more functional tests may be executed at a pre 2-Corner (P2C) testing phase. During P2C testing, one or more tests may be executed to test for functional failures and as a 2-Corner (2C) yield improvement process by screening for failures prior to committing the DUT 105 to a 2-Corner (2C) test. Functional tests performed during P2C testing may be run at ambient temperature without voltage margining. The functional tests performed during P2C may test for system functionality (e.g., traffic flow, image download) of the DUT 105 and/or PCB of the DUT 105. If the DUT 105 passes P2C testing, the DUT 105 may proceed to 2C testing for environmental screening and/or testing.

2-Corner (2C) testing may screen and/or test for functional failures not detected during P2C testing. 2C testing may be performed at corner temperature, which may be in a range of approximately −5 degrees Celsius to +55 degrees Celsius, as an example. Other ranges may be used. In addition, functional tests performed during 2C testing may utilize voltage margining. During 2C testing, functional tests that are performed may test for a major and/or system-level function of the DUT 105 (e.g., traffic flow, or ASIC functionality). If the DUT 105 passes 2C testing, the DUT 105 may proceed to highly accelerated stress screen (HASS) testing for further environmental screening and/or testing.

Functional tests performed during HASS testing may test for manufacturing defects under environmental stress, such as environmental temperature variation or vibration. Functional tests performed during HASS testing may identify and/or determine manufacturing defects including material, design, process, or workmanship defects. Functional tests performed during HASS testing may perform continuous system traffic tests under continuous and/or discrete temperature variation. The temperature variation may be performed in one or more temperature cycles. In addition or alternatively, the system traffic tests under temperature variation may include initially performing traffic tests at ambient temperatures and subsequently performing traffic tests while increasing the temperature to temperatures hotter than ambient temperatures (such as to +55 degrees Celsius) and decreasing the temperature to temperatures colder than ambient temperatures (such as to −5 degrees Celsius). In addition, functional tests performed during HASS testing may be performed under environmental stress (e.g., temperature variation or vibration) that are the same and/or different than functional tests performed during 2C testing, and may identify manufacturing defects not detected by 2C testing (e.g., defects related to solder quality such as bad solder joints).

An example functional test module 220 may include a functional test database 285 that may be configured to store and/or provide available functional tests to be performed on the DUT 105. The functional test database may also be configured to store instructions and/or other information associated with the functional tests that may be needed to perform the function tests. The functional test module 220 may further comprise a functional test controller module 290 that may be configured to access and/or identify the functional tests provided by the functional test database 285. The functional test controller module 290 may be configured to communicate with the operator interface 125 to provide the available functional tests provided by the functional test database 285 to the operator interface 125 and/or the output device 125 upon a request from the operator interface 125 for the available functional tests. In addition or alternatively, the functional test controller module 290 may be configured to select one or more functional tests provided by the database 285. In one example, the functional test controller module 290 may be configured to select the functional test based on a selection provide by the operator interface 125.

To perform the functional tests, the functional test controller module 290 may be configured to generate one or more functional test signals. A functional test signal may include instructions that are used to perform the functional test. In addition, the functional test signal may also include one or more test pattern. A test pattern may include characters, values, and/or sequences of characters and/or values. The values may comprise binary values or hexadecimal values, although other types of values may be used. The test patterns may comprise one or more test vectors. In addition or alternatively, the functional test signal may include one or more control parameters that are used to perform the functional test. Control parameters may include parameters that configure the DUT 105, such as parameters that set voltage or current levels on the DUT 105. In some examples, the control parameters may be part of the instructions. In addition or alternatively, the functional test controller module 290 may communicate with the operator interface 125 and/or the output device 135 to request the control parameters and/or receive the control parameters from the operator interface 125. The functional test controller module module 290 may also be configured to send the functional test signals to the DUT 105.

In addition or alternatively, the functional test module 220 may be include a diagnostic module 295 that may be configured to determine, identify, and/or receive a response from the DUT 105. The response from the DUT 105 may be referred to as an actual response. The diagnostic module 295 may be configured to compare the actual response with an expected response. Based on the comparison, the diagnostic module 295 may be configured to determine and/or identify whether the DUT 105 and/or one or more components of the DUT 105 has a functional defect, which of the components 105 has the functional defect, and/or what the functional defect is.

The system 200 may further include a BIST module 230. The BIST module 230 may be configured to determine and/or identify one or more structural defects and/or one or more functional defects of the DUT 105 or one or more components of the DUT 105 that the structural test module 210 and/or the functional test module 220 may not be configured to detect. As an example, where the structural test module 210 is configured to perform a boundary scan in accordance with IEEE 1149.1, 1532, and/or 1149.6, the structural test module 210 may not be configured to detect a structural defect for a power pin or a ground pin. Accordingly, an example BIST test may be configured to detect a structural defect for the power pin or the ground pin. In addition or alternatively, the BIST test may test for structural and/or functional defects that are internal to a package of the DUT 105 (e.g., core logic) and/or may test for structural and/or functional defects that are external to a package of the DUT 105 (e.g., I/O pins).

A BIST test may be performed on the DUT 105 using a port and/or pins of the DUT 105 that are as the port and/or pins of the DUT 105 that are used to perform one or more structural tests with the test module 210. For example, where the structural test module 210 is configured to perform a boundary scan in accordance with IEEE 1149.1, 1532, and/or 1149.6, the BIST test may be performed using and/or accessing the TAP (TDI/TDO/TCK/TMS/TRST) pins of the DUT 105.

The BIST module 230 may be configured to generate BIST output instructions, and may further be configured to send the BIST output instructions to the DUT 105 to perform one or more BIST tests associated with the BIST instructions. In one example, the DUT 105 includes a pattern generator to generate BIST test signals to perform the BIST testing. The BIST output instructions may be sent to the DUT 105 so that the pattern generator of the DUT 105 may generate the BIST test signals. Alternatively or in addition, the BIST output instructions may be stored in a BIST database 275. In one example, the BIST database 275 may be a component or a part of storage of the computing device 120, such as the memory of the computing device 120. Alternatively, the BIST database 275 may be a component or part of the data store 140. The BIST module may be configured to provide the BIST output instructions stored in the BIST database 275 to the DUT 105.

To generate the BIST output instructions, the BIST module 230 may include a BIST instrument database 265 that provides BIST tests that may be available to be performed on the DUT 105. Example BIST tests may include logic BIST (LBIST), high speed serializer deserializer (SERDES), ALLSCAN, and/or JTAG2SCSR. The ALLSCAN test may be used to shift out scanned register data through a JTAG interface of a component of the DUT 105 undergoing the BIST test. The ALLSCAN test may be used for debugging and/or performing diagnostics on the DUT 105 and/or a component of the DUT 105. The JTAG2CSR test may allow for the control of control/status registers (CSR) of a component (such as an ASIC) of the DUT 105 through the TAP port of the component. The JTAG2CSR test may use one or more JTAG instructions and/or a trailer data register (TDR) that may be configured to communicate CSR read and/or write commands to an interface or block designated for the JTAG2CSR test. The BIST instrument database 265 may also include information about the DUT 105 that is needed to perform one or more of the available BIST tests. Information about the DUT 105 may include BSDL data, BOM data, and/or Netlist data, similar to the data included in the CSF database 240. The BIST database 265 may also include instructions to perform the BIST test. The information indicating the data to be applied to the DUT 105 for performing the BIST test and an order of steps taken to perform the BIST test and/or operate a BIST engine of the DUT 105.

The BIST database 265 may be a component of and/or a part of storage of the computing device 120, such as the memory of the computing device 120. Alternatively, the BIST database 265 may be a component and/or a part of the data store 140.

The BIST module 230 may further include a parser module 270. The parser module 270 may be configured to convert the information stored in the BIST instrument database 265 into the BIST output instructions having a format that the DUT 105 and/or the pattern generator of the DUT 105 may use to generate one or more BIST test signals to perform one or more BIST tests. In one example, the format of the BIST output instructions may be Tool Command Language (TCL). In another example, the format of the BIST output instructions may be Serial Vector Format (SVF). In addition or alternatively, the parser module 270 may be configured to determine and/or identify an order and/or sequence of one or more BIST test signals to be sent to the DUT 105. In one example, the order and/or sequence of the one or more BIST test signals may be part of the BIST output instructions. In addition or alternatively, the parser module 270 may be configured to perform register mapping, which may provide a diagnostic module 280 of the BIST module 230 with the ability to identify one or more components (or circuit elements of a component) of the DUT 105 that may be detected as failing following a BIST test. In addition or alternatively, the parser 270 may be configured to store the BIST output instructions into the BIST database 275, as previously described.

The BIST module 230 may further include a BIST diagnostic module 280. The BIST diagnostic module 280 may be configured to determine whether a functional and/or structural defect revealed by a BIST test exists based on a received response of the DUT 105. For example, the diagnostic module 260 may be configured to compare an expected response associated with an input test pattern generated by the BIST pattern generator on the DUT 105 with an actual response of the DUT 105 to determine whether a structural defect and/or functional defect exists, the type of the defect (e.g., open, short), and/or the component and/or net that has the defect. The diagnostic module 280 may be configured to provide an output to the operator of the system 100, such as to the display of the computing device 120, that includes the results of the structural test.

Although system 200 includes the structural testing module 210, the functional testing module 220, and the BIST module 230, in other example systems, one or more of the modules may not be included. For example, an alternative system may include only a structural testing module and a functional testing module. Another alternative system may include only a BIST module and a functional testing module. In other alternative systems, only a structural testing module and a BIST module may be included. Alternatively or in addition, one or more modules 210, 220, 230, and/or one or more features or functions of one or more modules 210, 220, 230, may be combined into one module. For example, the structural testing module and the BIST module 210, 230 may be one module. Other configurations are possible.

Each of the structural testing module 210, the functional testing module 220, and the BIST module 230 may be activated and deactivated. When the structural testing module 210, the functional testing module 220, and/or the BIST module 230 is activated, the modules 210, 220, and/or 230 may be configured to generate and/or provide the DUT 105 with test signals and/or instructions to perform their respective tests. In one example configuration, when one of the modules 210, 220, 230 is activated, the other of the modules 210, 220, 230 are deactivated or disabled. In another example configuration, more than one or all of the modules 210, 220, and 230 may be activated simultaneously. For example, the structural test module 210 and the BIST module 230 may be activated while the functional test module is 220 deactivated. Similarly, while the functional test module 220 is activated, the structural test module 210 and the BIST module 230 are deactivated. Other configurations are possible.

The system 200, including the structural test module 210, the functional test module 220, and/or the BIST module 230, may be operatively coupled to the operator interface 125 of the computing device 120 (FIG. 1). The operator interface 125 may be configured to control the activation and deactivation of the modules 210, 220, and/or 230. For example, the operator interface 125 may be configured to select which of the modules 210, 220, and/or 230 are activated and/or deactivated. In one example, the operator interface 125 may be configured to provide a selection to an operator of the operator 125 to select which of the modules 210, 220, 230 to be activated/deactivated. The operator, through the operator interface 125, may select which of the modules 210, 220, 230 to be activated. In one example, when the structural test module 210 and the BIST module 230 are selected to be activated, the functional test module 220 may be deactivated. Similarly, when the structural test module 210 and the BIST module 230 are selected to be deactivated, the functional test module 220 may be activated.

The system 200 and/or the computing device 120 in which the system 200 may be implemented may be configured to be in and/or may be configured to switch between modes of operation. The system 200 and/or the computing device 120 may be configured in a structural test mode, a functional test mode, and/or a BIST mode when the structural test module 210, the functional test mode 220, and/or the BIST module 230, respectively, is activated. For example, if the structural test module 210 is activated, the system 200 and/or the computing device 120 may be in the structural test mode. Similarly, when the function test module 210 is activated, the system 200 and/or the computing device 120 may be in the functional test mode. Likewise, when the BIST module 230 is activated, the system 200 and/or the computing device 120 may in the BIST mode. When the system 200 and/or the computing device 120 is in a particular mode, the system 200 and/or the computing device 120 may be configured to perform the test for the particular mode and/or analyze one or more responses from the DUT 105 and/or diagnose the DUT 105 after the test is performed.

Referring back to FIG. 1, the operator interface 125 may be configured to control the structural testing, the functional testing, and/or the BIST testing of the DUT 105. The operator interface 125 may control the testing by receiving one or more inputs from an operator. When the system 200 and/or the computing device 120 is in the structural testing mode, example inputs may include: an input that activates and/or deactivates the structural testing mode; a structural test to run (e.g., EXTEST, EXTEST_PULSE, EXTEST_TRAIN, as defined in IEEE 1149.1, 1532, and/or 1149.6); and/or one or more components of the DUT 105 to be tested. In one example, the one or more components to be tested may be selected individually by component name and/or by a BSDL entity name. Alternatively or in addition, one or more components to be tested may be selected by type. As an example, only components that are ASICs may be selected. In addition or alternatively, an input for performing a structural test may include a net name of a net or a name of an individual pin or a plurality of pins. Another input may include a scan chain that identifies a chain of one or more components of the DUT 105 to be tested. Another example input when the system 200 and/or the computing device 120 is in the structural testing mode may be an algorithm to be used to generate one or more test patterns. In addition, an input may include test signal that includes instructions, a test pattern, a test vector, and/or a series of test patterns or test vectors that may be used to perform the structural testing. The test signal may be stored in the database 255 and may be saved under a file name. In addition or alternatively, an input when the system 200 and/or the computing device 120 is in the structural test mode may include a request to provide and/or list the components of the DUT 105 that are capable of receiving a structural test (e.g., capable of receiving a JTAG test in accordance with IEEE 1149.1, 1532, and/or 1149.6). Another input may include a request for a list of all the commands and/or other inputs that may be available to perform the structural test.

Similar inputs may be included when the system 200 and/or the computing device 120 is in the BIST mode. In addition or alternatively to the inputs described above for the structural testing mode, an input when system 200 and/or the computing device 120 is in the BIST mode may include a set of BIST output instructions that may be used and/or sent to the DUT 105 to perform the BIST test. The BIST output instructions may be stored in the BIST database 280. The BIST output instructions may be stored as a SVF file or a TCL file, although other formats or types of files may be used.

Similar inputs may be included when the system 200 and/or the computing device 120 is in the functional test mode. In addition or alternatively to the inputs described above for the structural test mode, an input when the system 200 and/or the computing device 120 is in the functional test mode may include a request to receive the available functional tests that may be performed on the DUT 105. Another input may include a selection of one or more functional tests that were provided in response to the request for the available functional tests. Additionally, an input may include one or more control parameters that may be used and/or included in the functional test signal to perform the functional test.

The operator interface 125 may be a command line interface (CLI) and each of the available inputs for a test may be identified and/or selected using a specific CLI command. The operator of the command line interface may provide the inputs by entering the specific CLI command. Other types of operator interfaces may be used, such as a graphical user interface (GUI) or a combination of CLI and a GUI. In addition, the operator interface 125 may comprise various input devices, such as a computer keyboard, a computer mouse, a display (e.g., a touch screen display), or combinations thereof as examples.

The system 100 may further include an output device 135 in communication with the controller 110 and/or the input device 130. The output device 135 may be a display device or a plurality of display devices, such as a cathode ray tube (CRT) display, a liquid crystal display (LCD), a plasma display, or a light emitting diode (LED) display, as examples. Other types of output devices may be used, such as audio or haptic devices, and/or combinations thereof.

The output device 135 may be configured to display diagnostic results following the structural testing, the functional testing, and or the BIST testing. Based on the results, one or more diagnostic modules 280 of the system 200 may determine whether the DUT 105 has one or more defects, what the one or more defects may be, and/or what actions may be taken to correct the one or more defects. The output device 135 may also display a status of the functional testing and/or the structural testing that is being performed on the DUT 105.

The diagnostic results and/or the system of the testing may be output in the form of a failure report. The failure report for a structural test may include and/or display a net name of a failed net, one or more reference designators for components of the DUT 105 that are connected to the failed net (and/or associated with the net name of the net), physical pins that are connected to the failed net (and/or associated with the net name of the net), one or more characteristics of the physical pins that are connected to the failed net (and/or associated with the net name of thenet), one or more failing conditions (e.g., stuck-at −1, stuck-at −0, and/or mismatch).

A failure report for a BIST test may include a BIST test that was run, one or more parameters used to perform the test, various status updates while the test was being run, expected and actual responses of the test, and an indication of whether the DUT 105 and/or one or more components of the DUT 105 undergoing the BIST test passed or failed the test.

A failure report for a functional test may include an identification of the DUT 105 and/or one or more components of the DUT undergoing the functional test. The identification may include a component name, a component part number, a serial number of the board, a board name, and/or a bill of material number. The failure report may also include whether the DUT 105 and/or one or more components of the DUT 105 undergoing the functional test failed the functional test; start and stop times of the functional test; temperatures at which the functional test was performed; one or more error code identifying the functional errors; an expected response of the functional test; and/or an actual response of the DUT 105.

In some examples, a failure report may include test and/or diagnostic results for more than one test. For example, one failure report may include test and/or diagnostic results for all of the tests that were run during a test cycle, and/or may include test and/or diagnostic results for one or more of the functional test, the structural test, and/or the BIST test.

In some systems, the input device 130 and the output device 135 may be configured as a single input/output (I/O) device. As an example, the I/O device may be a touch screen display device. A user may use a “touch” portion of the touch screen device as the input device 130 and/or a display portion of the touch screen devices as the output device 135.

In addition or alternatively, the system 200 and/or the computing device 120 may be configured to operate in the structural testing mode, the functional testing mode, the BIST mode, and/or switch between two or more of the modes while the DUT 105 is being subjected to thermal testing. As previously described, the DUT 105 may be housed or positioned in a test chamber that has or is connected to a temperature control unit. The temperature control unit may vary the environmental temperature within the test chamber. The DUT 105 inside the test chamber may be subjected to varying hot and cold temperatures over a thermal cycle. During the thermal cycle, the system 200 and/or the computing device 120 may be configured to perform one or more of the functional testing, the structural testing, and the BIST testing. For example, while the DUT 105 may be subjected to hotter than ambient temperatures (e.g., fifty-five degrees Celsius), the system 200 and/or the computing device 120 may be configured to perform a functional test on the DUT 105. In one example, the functional testing may be performed by activating the functional test module 220 and receiving one or functional testing inputs through the operator interface 125. After the functional testing has been completed, but while the DUT 105 is still being subjected to the thermal scan, the system 200 and/or the computing device 120 may switch to a different mode (e.g., the structural testing mode and/or the BIST mode) and the structural test and or the BIST test may be performed on the DUT 105. The system 200 and/or the computing device 120 may switch modes based on receiving an input activating a different module (e.g., the structural testing module 210 and/or the BIST module 230).

The mode of operation may be switched at a predetermined time (such as a predetermined time of the thermal cycle) and/or by a determination of the operator. The mode of operation may be determined to be switched after the completion of one test and/or predetermined results following the test. For example, if a functional error is determined and/or identified after a functional test is performed on the DUT 105, the system 200 and/or the computing device 120 may switch to one or both of the structural testing mode or the BIST mode and perform one or more structural tests and/or one or more BIST tests. Performing the structural tests and/or the BIST tests may facilitate in identifying one or more components of the DUT 105 that may be causing the functional error.

The mode of operation of the system 200 and/or the computing device 120 may be switched in any order and at any time. For example, the mode of operation may switch from functional testing to structural testing, from functional testing to BIST testing, from structural testing to functional testing, from structural testing to BIST testing, from BIST testing to functional testing, and/or from BIST testing to structural testing.

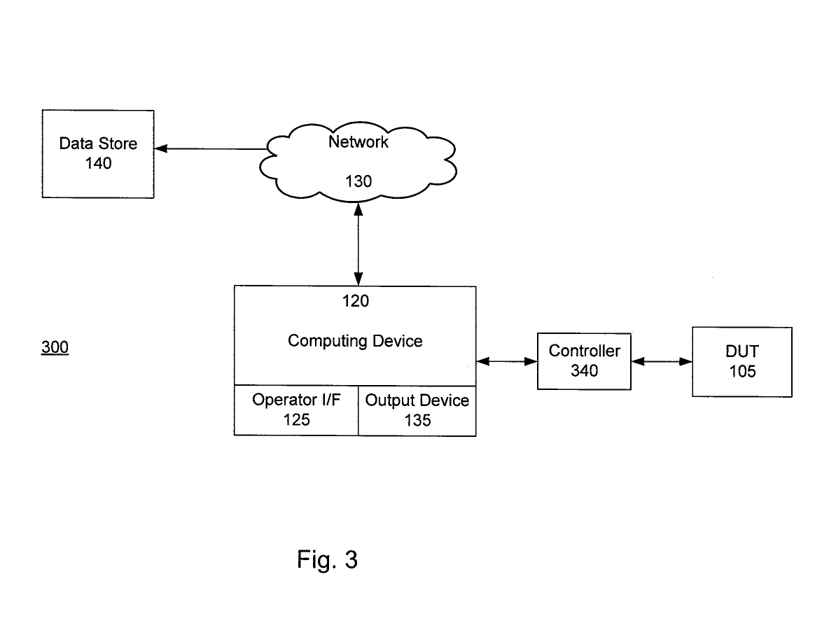

In other example systems, such as system 300 shown in FIG. 3, a controller 340 may be configured to communicate with the computing device 120 and the DUT 105. In addition, the controller may be configured to control the structural testing, the functional testing, and/or the BIST testing performed on the DUT 105. For example, the controller 340 may be configured to receive the structural, functional, and/or BIST test signals, and based on the received test signals, may be operable to configure the DUT 105 for undergoing the structural, functional, and/or BIST tests and receive the instructions and/or data for the particular tests. The system 300 and/or computing device 120 may determine memory mapping of the controller 340 so that the system 300 and/or computing device 120 may determine the addresses of the ports or pins of the DUT 105, so that the structural, functional, and/or BIST test signals may sent to the desired locations of the DUT 105. The controller may comprise one or more integrated circuits, such as one or more ASICs, FPGAs, or combinations thereof.

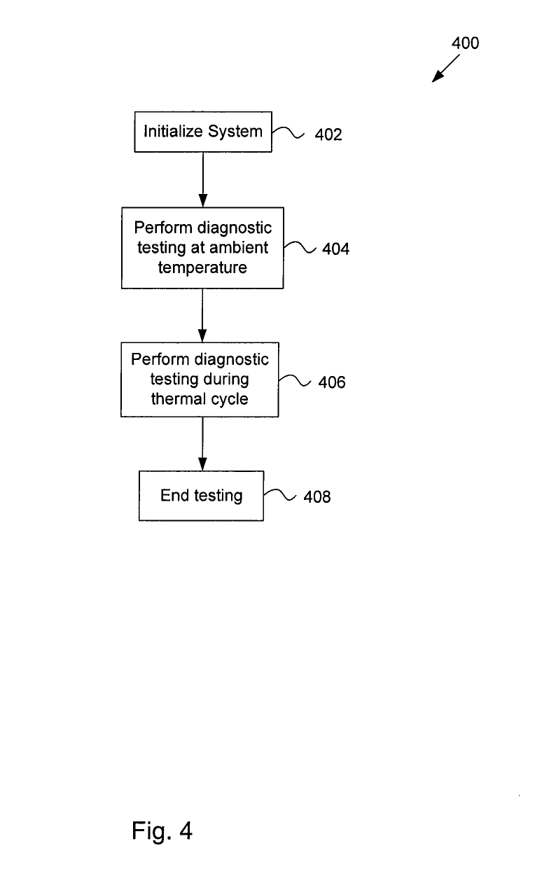

FIG. 4 is a flow chart illustrating an example method 400 that may be used by the system 100 and/or the system 200 to perform one or more diagnostic tests, including one or more structural tests and one or more functional tests, and/or one or more BIST tests. At block 402, the system is initialized. During initialization, the system may be powered up. Also during initialization, the DUT may be connected to the system, such as by being positioned in a test bench and/or a test chamber. Additionally, the DUT may be connected to system (such as the computing device 120 in FIG. 1) so that the DUT may receive test signals for performing the diagnostic tests. In addition, data used to perform functional testing, structural testing, and/or BIST testing may be loaded into the system and/or accessed by the system. For example, data may be loaded into the CSF database 240, including BSDL data, BOM data, and/or netlist data. Similarly, data may be loaded into the BIST Instrument database 265 to perform BIST testing. Likewise, data may be loaded into the functional test database to perform functional testing.

At block 404, one or more diagnostic tests, including one or more functional tests and one or more structural tests, and/or one or more BIST tests may be performed on the DUT at ambient temperatures. In one example, the system may prompt the user, such as through an operator interface and/or a display, to select a test to run. In another example, the system may be configured to automatically run a diagnostic test after initialization. For example, one of the functional tests, the structural tests, or the BIST tests may be set as a default test, and after initialization, the system may be configured to run the default test. In the example where the system provides a prompt, the system may receive a selection of the test to run, and in response, the module corresponding to the selected test may be activated. The system may be configured to prompt the operator to provide one or more inputs to run the diagnostic test, as described above. After receiving the one or more inputs, the system may run the selected test.

After the test is completed, the system may analyze the results of the test. As previously described, the system may be compare a response from the DUT with one or more expected responses that may be stored in and/or accessed by the system. To analyze the results, the system may use one or more diagnostic modules, such as diagnostic module 260 or diagnostic module 280. Based on the analysis, the system may be configured to output a report that indicates the results of the test. The report may indicate whether the DUT passed or failed the test. If the DUT failed, the report may indicate one or more components, pins, and/or nets where the failure occurred. The report may also include whether the system is capable of repairing the failure. The system may be configured to output the report electronically (such as on the display of the computing device 120) and/or provide a hard copy (such as a paper copy) of the report to the operator. The report may be presented so that the operator may evaluate the health of the DUT. In addition or alternatively, the system may be configured to repair the failures (should one or more failures have been identified by the test). In one example, the system may repair the failures only after the system receives an input from the operator to repair the failures. The system may be configured to store the results and/or the report, such as in data store 140.

After the analysis and/or repair, the system may determine whether or not to run another test. In one example, the system may be configured to automatically run another test. The determination to run another test may be based on whether a failure is identified from the initial or previously run test. For example, if a functional test is run and identifies a functional error, then the system may be configured to automatically perform a structural test and/or a BIST test. The system may be configured to execute and/or configure the next test based on the results of the initial or the previously run test. As an example, if a functional test identified one or more components of the DUT that failed the functional test, the system may use the results to determine and/or identify the components and/or establish a test chain on which to perform a structural test and/or a BIST test. In another example, the system may be configured to query the operator to run another test and/or prompt the operator select another test to run, and the determination by the system to run another test may be based on the operator selection. If the system determines not to run another test, the process may proceed to block 406 where one or more diagnostic tests may be run during thermal testing.

At block 406, one or more diagnostic tests, including one or more functional tests and one or more structural tests, and/or one or more BIST tests may be performed on the DUT during thermal testing. At block 406, the DUT may be subjected to temperatures hotter or colder than ambient temperature, as previously described. In one example, the system may prompt the user to select a test to be performed. In another example, the system may be configured to automatically perform a diagnostic test. The system may automatically perform a test based on a point in the thermal cycle. As an example, the thermal cycle may increase in temperature from ambient temperature to a predetermined hot temperature (e.g., fifty-five degrees Celsius). Once the predetermined hot temperature is reached, the system may be configured to automatically perform one or more diagnostic tests. Alternatively, once the predetermined hot temperature is reached, the system may be configured to prompt a user to select a test to be performed. Similarly, the thermal cycle may decrease from the predetermined hot temperature and/or ambient temperature to a predetermined cold temperature (e.g., minus ten degrees Celsius). In other examples, the operator of the system may select the diagnostic test to be performed based on the operator's own initiative. The system may be configured to provide a selection of a test to run for the user, independent and/or irrespective of, the point in thermal cycle.

After the system determines to run a test, the system may operate during the thermal cycle similarly to the operation as described in block 404. For example, the system may run the test, receive a response from the DUT, analyze the response, provide a failure report, and/or determine to run another test (either automatically or by receiving a user input). If the system determines that no more tests are to be run and/or the thermal cycle has ended, then the process may end at block 408.

FIG. 5 is a flow chart illustrating an example method 500 that may be used by the system 100 and/or the system 200 to perform one or more structural tests and/or one or more functional tests when a DUT is subjected to either ambient temperatures or a thermal cycle. At block 502, the system determines a diagnostic test, including a functional test, a structural test, or one or more BIST tests. In one example, the system may determine the diagnostic to be performed based on an operator input. The system may provide to the operator, such as through an operator interface and/or a display, a list of diagnostic tests that may be performed. The system may receive an input from the operator that indicates the operator's selection of the diagnostic test to be performed. In another example, the system may automatically determine the test to be performed. For example, the system may include a default test that the system is configured to initially perform. As another example, after the system performs a first test and a result (such as a failure) is identified, the system may be configured to automatically perform a second test upon identifying the result. In addition, at block 502, one or more parameters that may be used and/or needed to run the diagnostic test may be identified. In one example, the system may determine the parameters based on receiving inputs entered into the system by the operator, such as the inputs previously described. In another example, the system may be configured to automatically determine the test parameters based on the test that was selected or otherwise determined.

After the diagnostic test and the parameters for the diagnostic test are determined, at block 504, the diagnostic test may be run. To run the test, a test module corresponding to the diagnostic test, such as the structural module 210, the functional test module 220, and/or the BIST module 230 in FIG. 2, may be activated. The test module may generate instructions and/or one or more test patterns and may send and/or be used to send the instructions and/or one or more test patterns to the DUT to perform the diagnostic test. The instructions and/or the test patterns may be generated using data that is loaded and/or accessed by the system. Alternatively, the data may be loaded and/or accessed before running the test, such as during an initialization of the system or when the test is determined.

When or after the diagnostic test is run, results of the test and/or a response from the DUT may be received by the system. At block 506, the system may analyze the results to determine whether the DUT passed the test. Also, at block 506, the system may output or provide the operator with a report that includes the test results. At block 508, the system determines if the DUT passed the test based on the analysis at block 506. If the DUT passes the test, then at block 510, the results may be stored or archived. The results may be stored in storage locally to or remotely from the system. For example, the results may be stored in data store 140 of system 100 shown in FIG. 1. After the results are stored, then at block 514, the system may determine if another diagnostic test is performed. The system may be configured to execute and/or configure the next test based on the results of the initial or the previously run test. As an example, if a functional test identified one or more components of the DUT that failed the functional test, the system may use the results to determine and/or identify the components and/or establish a test chain on which to perform a structural test and/or a BIST test. In other examples, if the DUT passes the test, then the process may proceed directly to block 514 and determine whether another test is to be performed without storing the results.

Alternatively, if the DUT does not pass the test, then the system may have detected one or more errors or defects. At block 512, the system may repair one or more of the identified errors and/or defects. In one example, the system may automatically repair the errors and/or defects if possible. In other examples, the system may repair the errors and/or defects if possible, and in response to receiving an input from the operator to repair the errors and/or defects. In addition or alternatively, the system may store or archive the test results, such as in data store 140 shown in FIG. 1. After the system repairs the errors and/or archives the test results, at block 514 the system may determine whether to perform another test.

At block 514, the system may automatically determine to perform another test. For example, if a first diagnostic test identifies an error and/or defect, then the system may automatically perform a second diagnostic test. The second diagnostic test may be the same test or may be a different test than the first diagnostic test. Alternatively, the system may prompt the operator, such as through the operator interface and/or display, to input whether another test is to be performed. If another test is to be performed, then at block 502, the system may determine a diagnostic test to be performed and the process repeats. If another diagnostic test is not to be performed, at block 516, the process ends.

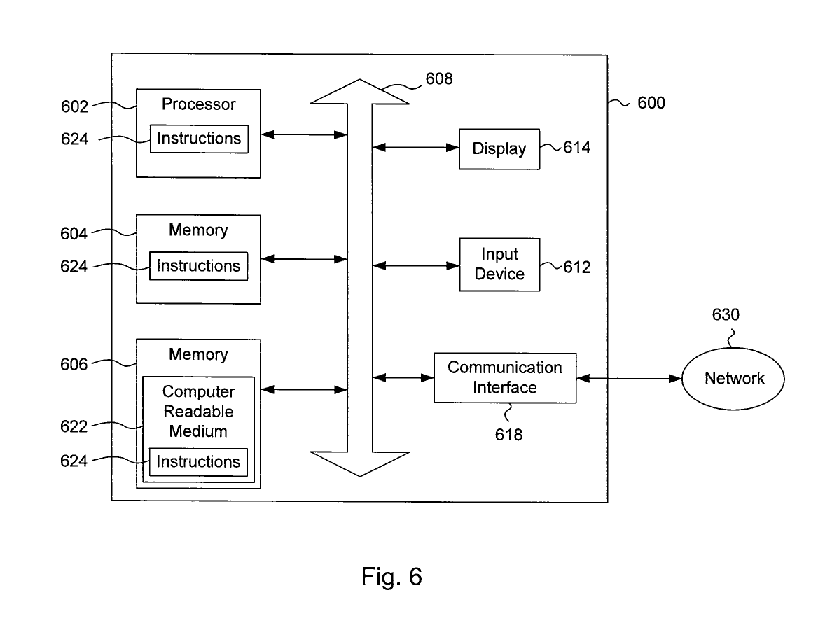

FIG. 6 illustrates a general computer system 600, which may represent the computing device 120, or any of the other computing devices referenced herein. The computer system 600 may include a set of instructions 624 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 624 (sequential or otherwise) that specify actions to be taken by that machine. In a particular embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, such as, a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 604 may include a cache or random access memory for the processor 602. Alternatively or in addition, the memory 604 may be separate from the processor 602, such as a cache memory of a processor, the system memory, or other memory. The memory 604 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 604 may be operable to store instructions 624 executable by the processor 602. The functions, acts or tasks illustrated in the figures or described herein may be performed by the programmed processor 602 executing the instructions 624 stored in the memory 604. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 614, such as a liquid crystal display (LCD), an organic light emitting diode (OLED), a flat panel display, a solid state display, a cathode ray tube (CRT), a projector, a printer or other now known or later developed display device for outputting determined information. The display 614 may act as an interface for the user to see the functioning of the processor 602, or specifically as an interface with the software stored in the memory 604 or in the drive unit 606.

Additionally, the computer system 600 may include an input device 612 configured to allow a user to interact with any of the components of system 600. The input device 612 may be a number pad, a keyboard, or a cursor control device, such as a mouse, or a joystick, touch screen display, remote control or any other device operative to interact with the system 600.

The computer system 600 may also include a disk or optical drive unit 606. The disk drive unit 606 may include a computer-readable medium 622 in which one or more sets of instructions 624, e.g. software, can be embedded. Further, the instructions 624 may perform one or more of the methods or logic as described herein. The instructions 624 may reside completely, or at least partially, within the memory 604 and/or within the processor 602 during execution by the computer system 600. The memory 604 and the processor 602 also may include computer-readable media as discussed above.

The present disclosure contemplates a computer-readable medium 622 that includes instructions 624 or receives and executes instructions 624 responsive to a propagated signal; so that a device connected to a network 630 may communicate voice, video, audio, images or any other data over the network 630. Further, the instructions 624 may be transmitted or received over the network 630 via a communication interface 618. The communication interface 618 may be a part of the processor 602 or may be a separate component. The communication interface 618 may be created in software or may be a physical connection in hardware. The communication interface 618 may be configured to connect with a network 630, external media, the display 614, or any other components in system 600, or combinations thereof. The connection with the network 630 may be a physical connection, such as a wired Ethernet connection or may be established wirelessly as discussed below. Likewise, the additional connections with other components of the system 600 may be physical connections or may be established wirelessly. In the case of a service provider server, the service provider server may communicate with users through the communication interface 618.

The network 630 may include wired networks, wireless networks, or combinations thereof. The wireless network may be a cellular telephone network, an 802.11, 802.16, 802.20, or WiMax network. Further, the network 630 may be a public network, such as the Internet, a private network, such as an intranet, or combinations thereof, and may utilize a variety of networking protocols now available or later developed including, but not limited to TCP/IP based networking protocols.

The computer-readable medium 622 may be a single medium, or the computer-readable medium 622 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 622 may include a solid-state memory such as a memory card or other package that houses one or more non-volatile read-only memories. The computer-readable medium 622 also may be a random access memory or other volatile re-writable memory. Additionally, the computer-readable medium 622 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

Various embodiments described herein can be used alone or in combination with one another. The foregoing detailed description has described only a few of the many possible implementations of the present invention. For this reason, this detailed description is intended by way of illustration, and not by way of limitation.

1. A method comprising:
configuring a device-under-test (DUT) in a test setup that performs a plurality of different types of diagnostic tests comprising a structural test and a functional test;
performing, with at least one processor, a first diagnostic test on the DUT, the first diagnostic test comprising the structural test or the functional test;
determining, with the at least one processor, results of the first diagnostic test;
performing, with at least one processor, a second diagnostic test on the DUT, the second diagnostic test being of a different type than the first diagnostic test, and the second diagnostic test being performed while the DUT is in the test setup.

2. The method of claim 1, further comprising:
wherein the second diagnostic test is performed based on the results of the first diagnostic test.

3. The method of claim 1, wherein determining the results of the first diagnostic test comprises identifying a component of the DUT that failed the first diagnostic test, and wherein performing the second diagnostic test on the DUT comprises selecting the identified failed component on which to perform the second diagnostic test.

4. The method of claim 1, wherein determining the results of the first diagnostic test comprises identifying a component of the DUT that failed the first diagnostic test, and wherein performing the second diagnostic test on the DUT comprises identifying a scan chain of the DUT based on the identified failed component.

5. The method of claim 1, wherein the structural test is a boundary scan test in accordance with Joint Test Action Group (JTAG) standards, and wherein the functional test is not in accordance with JTAG standards and comprises a system-level test that tests for proper functioning of the DUT.

6. The method of claim 1, wherein the test setup comprises a chamber that houses the DUT, the chamber creating an environment surrounding the DUT having varying temperatures; and wherein the method further comprises:
subjecting the DUT to a temperature that is hotter than ambient temperature or colder than ambient temperature, and
wherein the first diagnostic test and the second diagnostic test are performed while subjecting the DUT to the temperature.

7. The method of claim 1, wherein the plurality of different types of diagnostic tests further comprises a built-in-self-test (BIST) test.

8. The method of claim 1, further comprising:
receiving a signal indicative of an operator selection to perform the second diagnostic test.

9. One or more computer readable storage media encoded with software comprising computer executable instructions and when the software is executed operable to:
perform a first diagnostic test on a device-under-test (DUT), the first diagnostic test comprising one of a plurality of different types of diagnostic tests comprising a JTAG-based structural test and a non-JTAG-based functional test;
determine results of the first diagnostic test;
perform a second diagnostic test based on the results of the first diagnostic test, the second diagnostic test being of a different type than the first test.

10. The one or more computer readable storage media of claim 9, further comprising, wherein the determination of the results of the first diagnostic test comprises an identification of a component of the DUT that failed the first diagnostic test, and wherein the performance of the second diagnostic test on the DUT comprises a selection of the identified failed component on which to perform the second diagnostic test.

11. The one or more computer readable storage media of claim 9, wherein the determination of the results of the first diagnostic test comprises an identification of a component of the DUT that failed the first diagnostic test, and wherein the performance of the second diagnostic test on the DUT comprises an identification of a scan chain of the DUT based on the identified failed component.

12. The one or more computer readable storage media of claim 9, further comprising software that, when executed is further operable to:
receive a signal indicative of an operator selection to perform the second diagnostic test.

13. The one or more computer readable storage media of claim 9, further comprising software that, when executed is further operable to:
set and maintain a temperature of an environment surrounding the DUT to a temperature that is hotter than the ambient temperature or colder than the ambient temperature; and
perform the first diagnostic test and the second diagnostic test while the temperature is being maintained.

14. The one or more computer readable storage media of claim 9, wherein the plurality of different types of diagnostic tests further comprises a built-in-self-test (BIST) test.

15. A system comprising:
an operating environment comprising:
a structural test module that, when activated, is configured to perform a structural test on a device-under-test (DUT); and
a functional test module that, when activated, is configured to perform a non-JTAG-based functional test on the DUT;
wherein the operating environment is configured to switch between the structural test module being activated and the functional test module being activated.

16. The system of claim 15, further comprising a test chamber housing the DUT, the test chamber creating an environment of varying temperatures that surrounds the DUT, wherein the operating environment is configured to switch between the structural test module being activated and the functional test module being activated while a temperature of the environment is hotter than ambient temperature or colder than ambient temperature.

17. The system of claim 15, further comprising a communication interface operatively coupled to the structural test module and the functional test module,
wherein the communication interface is connected to the DUT and is configured to provide a structural test signal generated by the structural test module for performing the structural test, and to provide a functional test signal generated by the functional test module for performing the functional test,
wherein the operating environment is configured to switch between the structural test module being activated and the functional test module being activated without removal of connection between the communication interface and the DUT.

18. The system of claim 15, where the structural test module comprises a pattern generator module that is configured to generate one or more test patterns for performing a boundary-scan test.

19. The system of claim 15, wherein the operating environment further comprises a built-in-self-test (BIST) module that, when activated, is configured to perform a BIST test on the DUT, wherein the operating environment is further configured to switch between the structural test module being activated, the functional test module being activated, and the BIST module being activated.

20. The system of claim 15, wherein the functional test module is configured to determine test results of the functional test performed on the DUT, and wherein the structural test module is configured to generate a structural test signal used to perform the structural test based on the results of the functional test.
